(19) United States
(12) Patent Application Publication
(10) Pub. No.: US 2010/0332493 A1
(43) Pub. Date: Dec. 30, 2010

(54) SEMANTIC SEARCH EXTENSIONS FOR WEB SEARCH ENGINES

(75) Inventors: Kevin Haas, Sunnyvale, CA (US); Peter Mika, Barcelona (ES)

Correspondence Address: FIALA & WEAVER P.L.L.C.;C/O CPA GLOBAL, P.O. BOX 52050, MINNEAPOLIS, MN, 55402, US

(73) Assignee: Yahoo! Inc., Sunnyvale, CA (US)

(21) Appl. No.: 12/491,778

(22) Filed: Jun. 25, 2009

(51) Int. Cl. G06F 17/30

(52) U.S. Cl. 707/759; 704/9; 707/769; 707/770; 707/805

(57) ABSTRACT

Techniques are described herein that are capable of taking into consideration the intent of a user with respect to a search query received from the user. A Web server determines that the search query matches a reference query pattern. The Web server executes a semantic search extension application in response to the search query matching the reference query pattern. For example, values of respective parameters may be determined based on the search query matching the reference query pattern. In this example, semantic application results may be generated for presentation to the user based on the values of the respective parameters.

### BACKGROUND OF THE INVENTION

1. Field of the Invention

The present invention generally relates to Web searching. In particular, the present invention is related to semantic search extensions for Web search engines.

2. Background

A Web server is a computer (e.g., server) or other processing system that is configured to execute a software program that provides information to users in response to receiving hypertext transfer protocol (HTTP) requests from users. For example, the information may include Web pages, images, other types of files, output of executables residing on the Web server, etc. The information may be provided in the form of Web pages, such as hypertext markup language (HTML) documents and objects (e.g., files) that are linked therein, for example.

One type of software program that may be executed by a Web server is a Web search engine. A Web search engine searches for information on the World Wide Web (WWW) based on search queries that are provided by users. Conventional Web searching techniques typically match keywords that are included in a user's search query to metadata associated with Web sites, for example. The Web sites are ranked based on how closely their metadata matches the keywords. A list of the Web sites is provided to the user in an order corresponding to the rankings of the respective Web sites. The list of the Web sites is commonly referred to as the search results. For example, the Web site having the highest ranking is usually listed first in the search results.

Search results that are provided using conventional Web searching techniques typically do not take into consideration the intent of a user with respect to objects that are specified in the keywords of a search query. For instance, search queries often refer to objects (e.g., nouns) without providing intent (e.g., verbs) regarding the objects. Even if a search query were to include intent, conventional Web searching techniques generally overlook such intent.

Thus, systems, methods, and computer program products are needed that are capable of taking into consideration the intent of a user with respect to a search query received from the user.

### BRIEF SUMMARY OF THE INVENTION

Various approaches are described herein for, among other things, utilizing semantic search extensions for Web search engines. Example embodiments are capable of executing semantic search extension applications to take into consideration the intent of a user with respect to a search query received from the user. A semantic search extension application extends the processing capability associated with a Web search engine to include semantic analysis of a search query. The semantic analysis includes processing an interpreted (e.g., parsed) version of the search query. The semantic search extension application provides semantic application results that are based on the semantic analysis.

For instance, a Web server may determine that a search query received from a user matches a reference query pattern. Example embodiments are configured to execute a semantic search extension application in response to the search query matching the reference query pattern. The reference query pattern may be generated using an expression language or may be defined by a more complex algorithm. The reference query pattern may be parameterized, such that matching the search query to the reference query pattern determines the values for a set of respective parameters. The intent of the user may be derived based on the search query matching the reference query pattern. For instance, the values of the respective parameters may indicate the intent of the user. Accordingly, the semantic application results may be based on the values of the respective parameters.

In particular, a method is described for utilizing a semantic search extension application. In accordance with the method, a determination is made that a search query received from a user matches a reference query pattern. A semantic search extension application is executed in response to the search query matching the reference query pattern. For example, values of respective parameters may be determined based on the search query matching the reference query pattern. In accordance with this example, semantic application results may be generated for presentation to the user based on the values of the respective parameters.

A Web server is also described. The Web server includes a first determination module and a semantic search extension module. The first determination module is configured to determine that a search query received from a user matches a reference query pattern. The semantic search extension module is configured to execute a semantic search extension application in response to the search query matching the reference query pattern. The semantic search extension module includes a second determination module and an application results module. The second determination module is configured to determine values of respective parameters based on the search query matching the reference query pattern. The application results module is configured to generate semantic application results for presentation to the user based on the values of the respective parameters.

A computer program product is also described. The computer program product includes a computer-readable medium having computer program logic recorded thereon for enabling a processor-based system to take into consideration the intent of a user with respect to a search query received from the user. The computer program logic includes a first program logic module and a second program logic module. The first program logic module is for enabling the processor-based system to determine that the search query received from the user matches a reference query pattern. The second program logic module is for enabling the processor-based system to execute a semantic search extension application in response to the search query matching the reference query pattern. The second program logic module includes instructions for enabling the processor-based system to determine values of respective parameters based on the search query matching the reference query pattern. The second program logic module further includes instructions for enabling the processor-based system to generate semantic application results for presentation to the user based on the values of the respective parameters.

Further features and advantages of the disclosed technologies, as well as the structure and operation of various embodiments, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate embodiments of the present invention and, together with the description, further serve to explain the principles involved and to enable a person skilled in the relevant art(s) to make and use the disclosed technologies.

FIG. 1 is a block diagram of an example computer system in accordance with an embodiment described herein.

FIGS. 2, 10, and 12 depict flowcharts of methods for utilizing a semantic search extension application in accordance with embodiments described herein.

FIGS. 3, 7, 9, and 11 are block diagrams of example implementations of a Web server shown in FIG. 1 in accordance with embodiments described herein.

FIGS. 4, 6, and 8 depict flowcharts of methods for performing a semantic analysis in accordance with embodiments described herein.

FIG. 5 is a block diagram of an example implementation of a semantic search extension module shown in FIG. 3 in accordance with embodiments described herein.

FIG. 13 is a block diagram of an example implementation of a computer system shown in FIG. 1 in accordance with embodiments described herein.

FIG. 14 is a block diagram of a computer that may be used to implement one or more aspects of the present invention.

The features and advantages of the disclosed technologies will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

### I. Introduction

The following detailed description refers to the accompanying drawings that illustrate example embodiments of the present invention. However, the scope of the present invention is not limited to these embodiments, but is instead defined by the appended claims. Thus, embodiments beyond those shown in the accompanying drawings, such as modified versions of the illustrated embodiments, may nevertheless be encompassed by the present invention.

References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the art to implement such feature, structure, or characteristic in connection with other embodiments whether or not explicitly described.

### II. Example Embodiments Utilizing Semantic Search Extensions for Web Search Engines

Example embodiments are capable of executing semantic search extension applications to take into consideration the intent of a user with respect to a search query received from the user. A semantic search extension application extends the processing capability associated with a Web search engine to include semantic analysis of a search query. The semantic analysis includes processing an interpreted (e.g., parsed) version of the search query. The semantic search extension application provides semantic application results that are based on the semantic analysis.

For instance, a Web server may determine that a search query received from a user matches a reference query pattern. Example embodiments are configured to execute a semantic search extension application in response to the search query matching the reference query pattern. The reference query pattern may be generated using an expression language or may be defined by a more complex algorithm. The reference query pattern may be parameterized, such that matching the search query to the reference query pattern determines the values for a set of respective parameters. The intent of the user may be derived based on the search query matching the reference query pattern. For instance, the values of the respective parameters may indicate the intent of the user. Accordingly, the semantic application results may be based on the values of the respective parameters.

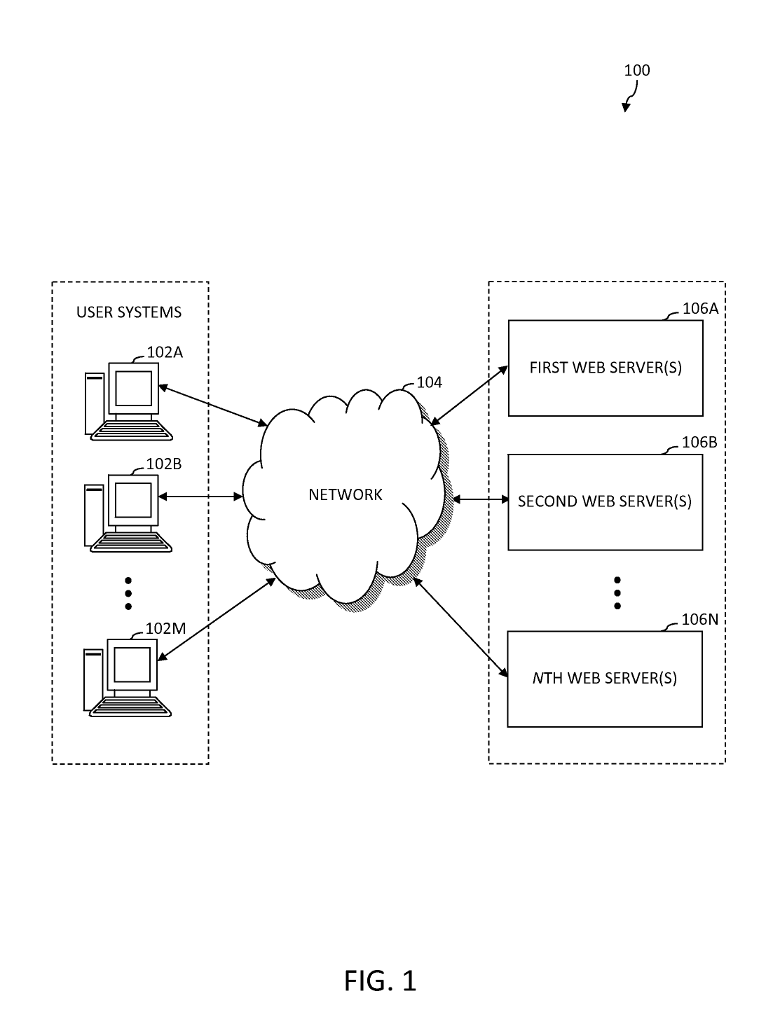

FIG. 1 is a block diagram of an example computer system 100 in accordance with an embodiment described herein. Generally speaking, computer system 100 operates to provide information to users in response to hypertext transfer protocol (HTTP) requests provided by the users. The information may include Web pages, images, other types of files, output of executables, etc. In accordance with example embodiments, computer system 100 operates to provide semantic application results to users in response to search queries provided by the users. The semantic application results are based on semantic analyses performed by semantic search extension applications, which extend the processing capabilities of Web search engines. Further detail regarding semantic analysis and example embodiments is provided in the following discussion.

As shown in FIG. 1, computer system 100 includes a plurality of user systems 102A-102M, a network 104, and a plurality of Web servers 106A-106N. Communication among user systems 102A-102M and Web servers 106A-106N is carried out over network 104 using well-known network communication protocols. Network 104 may be a wide-area network (e.g., the Internet), a local area network (LAN), another type of network, or a combination thereof.

User systems 102A-102M are computers or other processing systems, each including one or more processors, that are capable of communicating with Web servers 106A-106N. User systems 102A-102M are capable of accessing Web sites hosted by Web servers 104A-104N, so that user systems 102A-102M may access information that is available via the websites. User systems 102A-102M are configured to provide HTTP requests to Web servers 106A-106N for requesting information stored on (or otherwise accessible via) Web servers 106A-106N. For instance, a user may initiate an HTTP request for information using a Web crawler, a Web browser, or other client deployed on a user system 102 that is owned by or otherwise accessible to the user.

Web servers 106A-106N are computers or other processing systems, each including one or more processors, that are capable of communicating with user systems 102A-102M. Web servers 106A-106N are configured to host respective Web sites, so that the Web sites are accessible to users of computer system 100. Web servers 106A-106N are further configured to execute software programs that provide information to users in response to receiving hypertext transfer protocol (HTTP) requests from users. For example, the information may include Web pages, images, other types of files, output of executables residing on the Web servers, etc. The software programs that are executing on Web servers 106A-106N may provide Web pages that include interface elements (e.g., buttons, hyperlinks, etc.) that a user may select for accessing the other types of information. The Web pages may be provided as hypertext markup language (HTML) documents and objects (e.g., files) that are linked therein, for example.

One type of software program that may be executed by any one or more of Web servers 106A-106N is a Web search engine. A Web search engine searches for information on the World Wide Web (WWW) based on search queries that are provided by users. For instance, the Web search engine may search among Web servers 106A-106N for the requested information. Upon discovering instances of information that are relevant to a search query, the Web search engine ranks the instances based on their relevance to the search query. The Web search engine provides a list that includes each of the instances in an order that is based on the respective rankings of the instances. The list may be referred to as the search results corresponding to the search query.

A semantic search extension application is another type of software application that may be executed by any one or more of Web servers 106A-106N. A semantic search extension application extends the processing capability associated with a Web search engine to include semantic analysis of a search query. The semantic search extension application provides semantic application results that are based on the semantic analysis. For example, the semantic search extension application may determine values of respective parameters based on the search query matching a reference query pattern. In accordance with this example, the semantic search extension application may generate the semantic application results based on the values of the respective parameters.

Semantic application results are distinct from search results that may be generated by a Web search engine, though the semantic application results may be based on such search results. The semantic application results are provided to the user who provided the search query in addition to or in lieu of such search results. In fact, the semantic search extension application may provide the semantic application results even if a Web search engine does not provide search results. For instance, the Web search engine need not necessarily perform a search operation in order for a semantic search extension application to generate the semantic application results.

It will be recognized that any one or more user systems 102A-102M may communicate with any one or more Web servers 106A-106N. Although user systems 102A-102M are depicted as desktop computers in FIG. 1, persons skilled in the relevant art(s) will appreciate that user systems 102A-102M may include any client-enabled system or device, including but not limited to a laptop computer, a personal digital assistant, a cellular telephone, or the like.

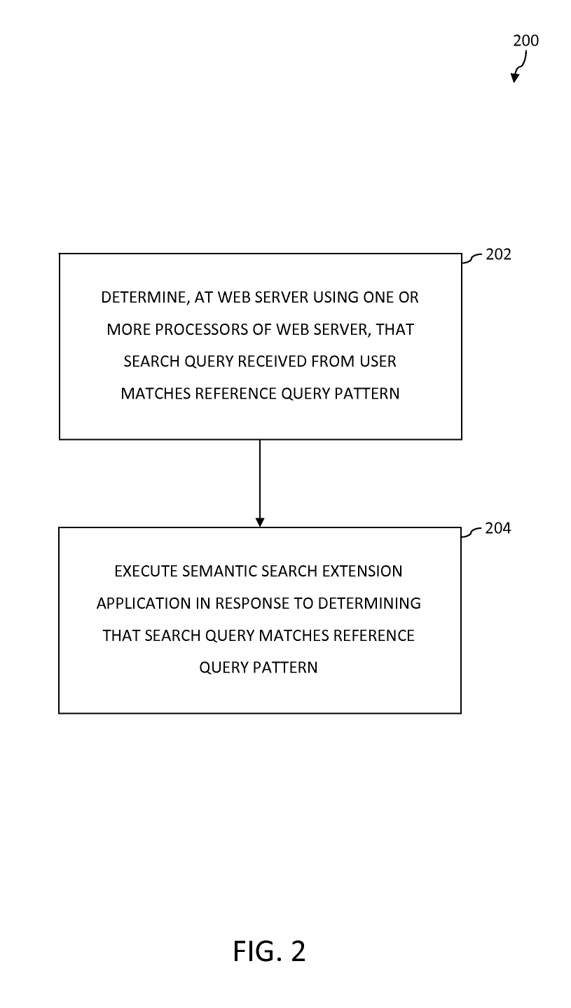

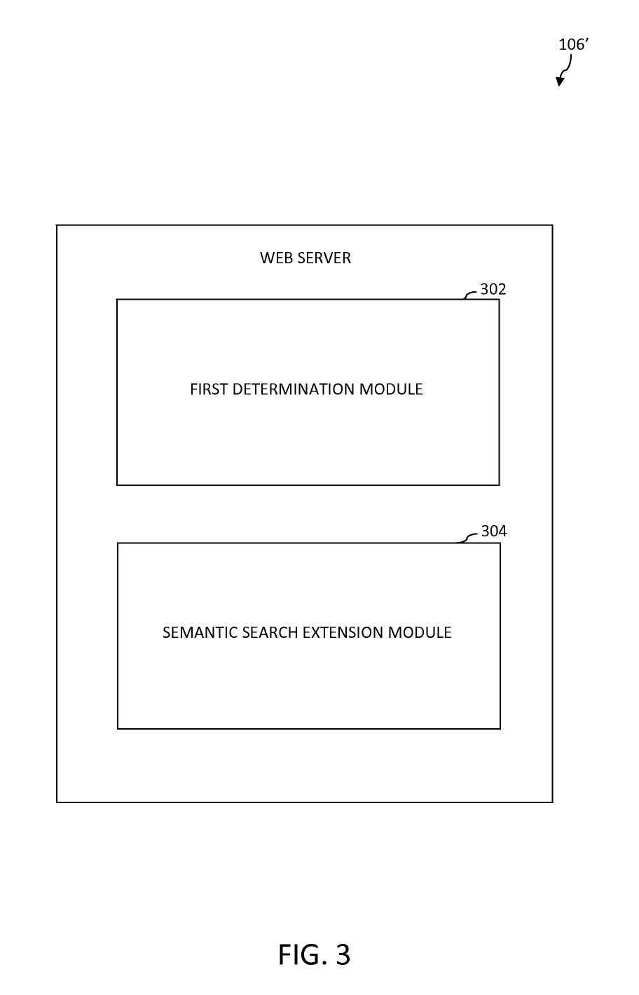

FIG. 2 depicts a flowchart 200 of a method for utilizing a semantic search extension application in accordance with embodiments described herein. Flowchart 200 is described from the perspective of a Web server. Flowchart 200 may be performed by any of Web servers 106A-106N of computer system 100 shown in FIG. 1, for example. For illustrative purposes, flowchart 200 is described with respect to a Web server 106′ shown in FIG. 3, which is an example of a Web server 106, according to an embodiment. In this document, whenever a prime is used to modify a reference number, the modified reference number indicates an example (or alternate) implementation of the element that corresponds to the reference number.

As shown in FIG. 3, Web server 106′ includes a first determination module 302 and a semantic search extension module 304. Further structural and operational embodiments will be apparent to persons skilled in the relevant art(s) based on the discussion regarding flowchart 200. Flowchart 200 is described as follows.

As shown in FIG. 2, the method of flowchart 200 begins at step 202. In step 202, a determination is made that a search query received from a user matches a reference query pattern. The determination is made at a Web server using one or more processors of the Web server. For instance, the search query may be deemed to match the reference query pattern if the search query includes a word, combination of words, or arrangement thereof, as specified by the reference query pattern. In an example implementation, the determination that the search query matches the reference query pattern is made at first determination module 302 of Web server 106′ in FIG. 3.

According to an embodiment, the reference query pattern is defined by the user. For instance, the user may log into a service that is provided by a Web search engine provider, such as Yahoo! Inc., Google Inc., IAC/InterActiveCorp, Microsoft Corporation, or any other suitable Web search engine provider. Once the user is logged into the service, the user may define the reference query pattern that is to be compared to search queries of the user or to search queries of a plurality of users that includes the user who defines the reference query pattern.

In accordance with another embodiment, the reference query pattern is associated with a class of queries that includes the search query received from the user. For instance, search queries that are directed to obtaining information regarding airline flights may be associated with a “flight” class of queries. The intent of the user to obtain information regarding airline flights may be derived based on the user's search query matching a reference query pattern that is associated with the “flight” class of queries.

One example reference query pattern that may be associated with the “flight” class of queries is as follows: <flight> <from> <to> <date>. This example reference query pattern includes four fields for illustrative purposes. It will be recognized that a reference query pattern may include any number of fields. The first field, <flight>, may be satisfied by one or more designated words (e.g., “flight”, “airfare”, “air travel”, “airplane trip”, etc.). The <from> and <to> fields may be satisfied by any of a plurality of respective locations, such as airport abbreviations, airport names, city names, state names, country names, landmarks, attractions, other indicators of locations, or combinations thereof. The <date> field may be satisfied by any of a variety of date formats (“July 4^{th}, 2010”, “20100704”, “07/04/2010”, etc.). The fourth of July is used merely as an example. It will be recognized that any date may be used in the <date> field. Each combination of words that may be included in the “flight” class of queries described above corresponds to a respective search query that is included in the “flight” class of queries.

At step 204, a semantic search extension application is executed in response to determining that the search query matches the reference query pattern. In an example implementation, semantic search extension module 304 executes the semantic search extension application.

According to an embodiment, the semantic search extension is executed based on a default association between the reference query pattern, the semantic search extension application, and potentially the user. For example, a first reference query pattern may be associated with a first semantic search extension application, a second reference query pattern may be associated with a second semantic search extension application, and so on. In accordance with this example, the first semantic search extension application may be executed in response to a search query matching the first reference query pattern, the second semantic search extension application may be executed in response to a search query matching the second reference query pattern, and so on, regardless which user provides the search query.

In another example, different semantic search extension applications may be executed in response to a search query matching a reference query pattern, depending on which user provided the search query. In accordance with this example, the first semantic search extension application may be executed if a first user provides the search query, and the second semantic search extension application may be executed if a second user provides the search query.

In yet another example, the reference query patterns associated with respective users for triggering the execution of a semantic search extension application need not necessarily be the same. For instance, an “Epicurious®” application may be executed in response to a first user's search query matching a first reference query pattern defined as including the word “recipe”. The “Epicurious®” application may also be executed in response to a second user's search query matching a second reference query pattern defined as including the word “cooking”. Accordingly, the same semantic search extension application may be executed in response to search queries from different users matching different respective reference query patterns

According to still another embodiment, the semantic search extension application is based on a template that is associated with a class of queries that includes the search query received from the user. Example classes may include but are not limited to a “flight” class, a “restaurant” class, an “office supplies” class, etc. For example, the template may define a structure of the output of the semantic search extension application with regard to the class of queries. In another example, the template may be associated with a designated company. For instance, the designated company may have purchased the rights to have its application executed in response to a determination that a search query falls within the scope of the class of queries that corresponds to the reference query pattern. In accordance with this example, the “office supplies” class of queries may be associated with a template used in a semantic search extension application provided by Office Depot Inc., Office Max Inc., or another office supplies retailer or distributor.

In accordance with an embodiment, the semantic search extension application is algorithmic. For instance, a first percentage of search queries that match the reference query pattern may be allocated to a first semantic search extension application, a second percentage of search queries that match the reference query pattern may be allocated to a second semantic search extension application, and so on. Accordingly, the semantic search extension application that is executed in response to the search query matching the reference query pattern may be determined based on an algorithm that is configured to execute semantic search extension applications in accordance with the allocated percentages.

According to another embodiment, the semantic search extension application is defined by the user. For instance, the user may log into a service that is provided by the Web server. Once the user is logged into the service, the user may define the semantic extension application that is to be executed in response to the search query matching the reference query pattern. For example, the user may select the semantic search extension application from a plurality of semantic search extension applications. For instance, if the user wishes to define an application to be executed in response to a search query that belongs to a “flight” class of queries, the user may select from a plurality of semantic search extension applications directed to the “flight” class of queries. For instance, the user may select from a “Yahoo!® Travel” application, an “Expedia®” application, an “Orbitz®” application, a “Travelocity®” application, or any other suitable application.

In another example, the user may develop the semantic search extension application and provide the application to the Web server. In accordance with this example, the user need not necessarily define the application that is developed by the user to be the application that is executed in response to the search query matching the reference query pattern. In yet another example, the application is developed by a Web search engine provider or a third party (e.g., some other company or person).

It should be noted that a developer may provide structured data to the Web server to facilitate the generation of the reference query pattern, though the scope of the example embodiments is not limited in this respect. For instance, the developer may provide the structure data using microformats, resource description framework (RDF) query language, a standardized datafeed, or any other suitable technique.

According to yet another embodiment, the user may define different semantic extension applications for different reference query patterns that are defined by the user. For example, the user may define the “Yahoo!® Travel” application for execution in response to the search query including the word “flight”. In this example, the reference query pattern associated with the “Yahoo!® Travel” application may be defined as any combination of characters or words that includes the word “flight”. The user may define the “Expedia®” application for execution in response to the query beginning with the word “vacation”. In this example, the reference query pattern associated with the “Expedia®” application may be defined as any combination of characters or words that begins with the word “vacation”. In one aspect, both the “Yahoo!® Travel” application and the “Expedia®” application may be executed in response to a search query matching the respective reference query patterns. For instance, the search query “vacation flight to from LAX to Barbados on May 3, 2010” matches the reference query patterns associated with the respective “Yahoo!® Travel” and “Expedia®” applications. In another aspect, either the “Yahoo!® Travel” application or the “Expedia®” application may be executed in response to a search query matching the respective reference query patterns, depending on a default preference or a preference of the user.

According to still another embodiment, the semantic search extension application is based on a query history of the user. For instance, queries in the user's query history may be used to determine the intent of the user with respect to a current search query. If the user's query history reveals that the user frequently requests (or has recently requested) information regarding books, a search query “Barcelona Spain” may result in the execution of a book retailer application, such as a “Yahoo!® Shopping” application, a “Borders®” application, a “Barnes & Noble®” application, an “Amazon.com®” application, etc. On the other hand, if the user's query history reveals that the user frequently requests (or has recently requested) information regarding travel destinations, the same search query of “Barcelona Spain” may result in the execution of a travel application, such as a “Yahoo!® Travel” application, an “Expedia®” application, an “Orbitz®” application, a “Travelocity®” application, etc.

It should be noted that the query history of the user may be used to promote a semantic search extension application, even if that application is not executed in response to the search query matching the reference query pattern. For instance, a recommendation may be provided to the user using a client (e.g., a Web browser), providing the user a description of the promoted semantic search extension application, an opportunity to use the application, and/or an opportunity to opt-in or make the application a default application for the user. The terms “opt-in” and “default” are discussed in greater detail in the following paragraph.

In an example, a developer of a semantic search extension application may (or may not) receive payment in response to execution of the semantic search extension application. In a first aspect, a fee may be paid to the developer each time the semantic search extension application is executed. In a second aspect, a fee may be paid to the developer in response to execution of the semantic search extension application a designated number of times. These example fee arrangements are provided for illustrative purposes and are not intended to be limiting. It will be recognized that a developer may receive payment in accordance with any suitable fee arrangement.

In another example, the developer of the semantic search extension application and/or a user who accesses the application may (or may not) be charged a fee in response to execution of the semantic search extension application with respect to the user. In a first aspect, access to the semantic search extension application may be provided in accordance with a subscription service. For instance, a fee that is charged for execution of the semantic search extension application may be incorporated into or charged in addition to a fee that is charged for the subscription service. In a second aspect, the semantic search extension application may be provided as a sponsored application by an advertiser. For instance, a fee may be charged for each instance of the semantic search extension application that is displayed as a sponsored application to the user. Alternatively, a fee may be charged for a designated number of instances in which the semantic search extension application is displayed as a sponsored application (with respect to a user or without regard to any particular user). For instance, a first fee may be charged for the first one hundred instances in which the semantic search extension application is displayed, a second fee may be charged for the next fifty instances, and so on. The example fee arrangements discussed herein are not intended to be limiting. It will be recognized that a developer and/or a user may be charged a fee in accordance with any suitable fee arrangement.

A semantic search extension application may be associated with an execution status. Example execution statuses include but are not limited to an opt-in status, an opt-out status, or a default-on status. An application having an opt-in status (a.k.a. an opt-in application) is an application that is not executed with respect to a user unless the user chooses for the application to be executed. An application having an opt-out status (a.k.a. an opt-out application) is an application that is executed with respect to a user unless the user chooses for the application not to be executed. An application having a default-on status (a.k.a. a default-on application) is an application that is executed with respect to a user, regardless whether the user chooses to have the application executed. For instance, a default-on application may be replaced by another application, which then becomes the default-on application.

Web server 106′ may be configured to measure acceptance of semantic search extension applications in the market place. An application's acceptance in the market place may be determined based on a number of users that use the application, a number of instances in which the application is used in the market place (e.g., among all users), a rating given to the application by users, etc. Web server 106′ may change the execution status of any one or more of the semantic search extension applications based on their respective acceptances in the marketplace.

It will be recognized that a plurality of semantic search extension applications may be executed in response to the search query matching the reference query pattern.

The characteristics (e.g., default association, template, algorithm, user-defined, based on user's query history, execution status, etc.) associated with semantic search extension applications that are included in the plurality of semantic search extension applications may differ or be the same. For instance, the semantic search extension applications may have at least one characteristic in common, no characteristics in common, all characteristics in common, etc.

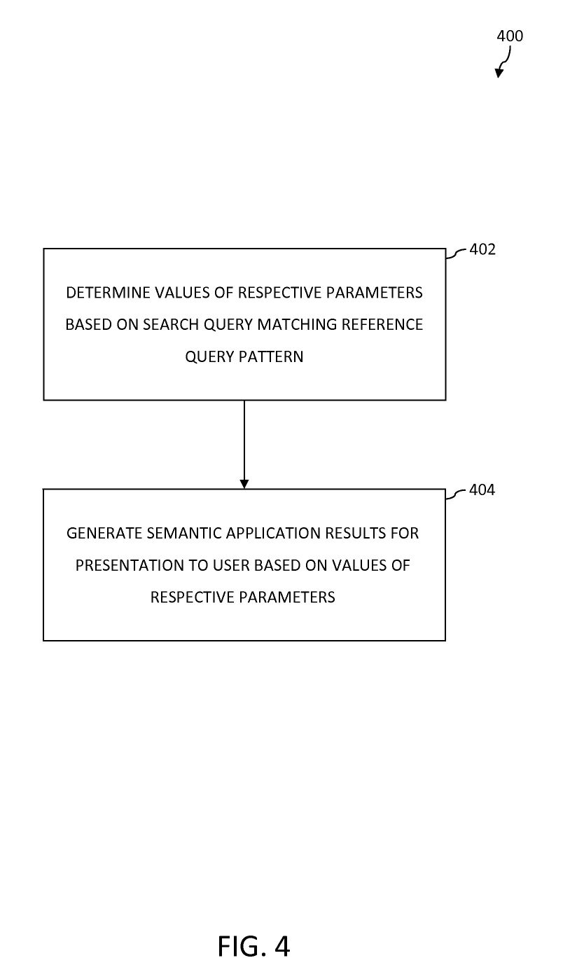

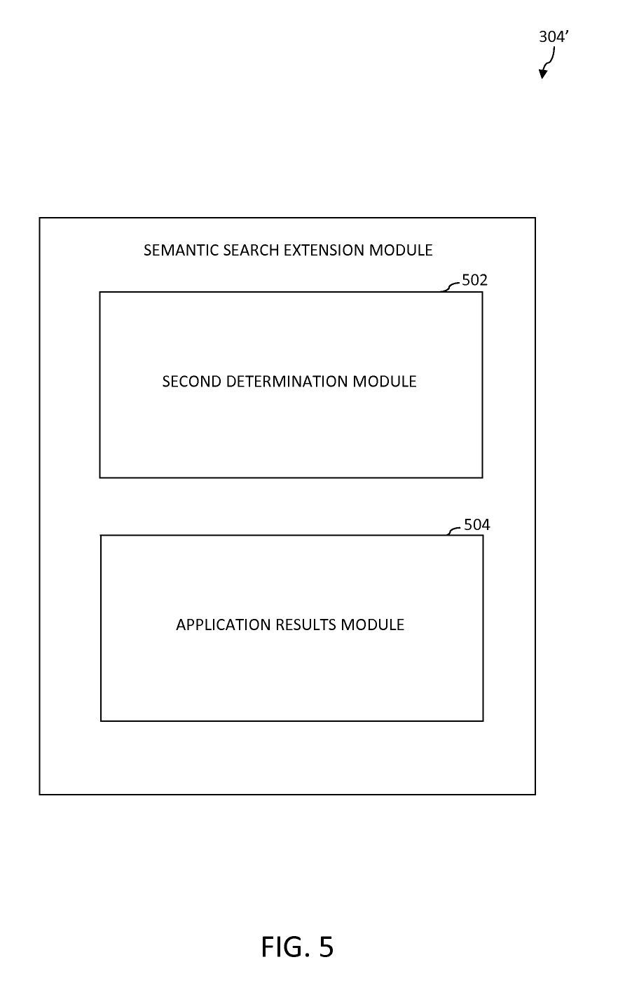

FIG. 4 depicts a flowchart 400 of a method for performing a semantic analysis in accordance with embodiments described herein. Flowchart 400 may be performed by semantic search extension module 304 shown in FIG. 3, for example. For illustrative purposes, flowchart 400 is described with respect to a semantic search extension module 304′ shown in FIG. 5, which is an example of a semantic search extension module 304, according to an embodiment. As shown in FIG. 5, semantic search extension module 304′ includes a second determination module 502 and an application results module 504. Further structural and operational embodiments will be apparent to persons skilled in the relevant art(s) based on the discussion regarding flowchart 400. Flowchart 400 is described as follows.

As shown in FIG. 4, the method of flowchart 400 begins at step 402. In step 402, values of respective parameters are determined based on a search query matching a reference query pattern. In an example implementation, second determination module 502 determines the values of the respective parameters.

According to an embodiment, the values of the respective parameters may be the values of respective fields of the reference query pattern. In a first example, a reference query pattern associated with a “flight” class of queries may include the following fields: <flight> <from> <to> <date>. Assuming that the search query in this example is “flight San Diego Boston Jan 23” for purposes of illustration, the values of the <flight>, <from>, <to>, and <date> fields of the reference query pattern are respectively “flight”, “San Diego”, “Boston”, and “January 23” of the current year or the following year depending on whether January 23 of the current year is past. Thus, in this example, the values of the respective parameters are “flight”, “San Diego”, “Boston”, and “January 23” of the current year or the following year depending on whether January 23 of the current year is past.

In a second example, a search query of “chicken recipes” may match a reference query pattern that is defined as including the word “recipe”. In accordance with this example, the words “chicken” and “recipes” may be the values of the respective parameters.

At step 404, semantic application results are generated for presentation to the user based on the values of the respective parameters. The semantic application results may be further based on information (e.g., preferences of the user) in addition to the values of the respective parameters, though the scope of the example embodiments is not limited in this respect. In an example implementation, application results module 504 generates the semantic application results.

In accordance with the first example described above, in which the values of the respective parameters are “flight”, “San Diego”, “Boston”, and “January 23”, generating the semantic application results may include matching the values of the respective parameters against flights that are available from one or more airline carriers. In accordance with this example, the semantic application results may include a list of flights that are available from San Diego to Boston on January 23. The flights may be arranged by price, airline carrier, travel company that is offering the flight, etc. Generating the semantic application results may include filtering the flights based on one or more criteria before the semantic application results are generated. Example criteria include but are not limited to seating arrangement (e.g., aisle seat, middle seat, window seat, row number, seat class, availability of multiple (e.g., adjacent) seats in same row, etc.), plane size, number of layovers, layover city, flight duration, flight departure time, flight arrival time, etc.

In accordance with the second example described above, in which the values of the respective parameters are “chicken” and “recipes”, generating the semantic application results may include providing a list of popular chicken recipes, providing tips on how to cook chicken, recommending wines for pairing with chicken, etc. Generating the semantic application results may include filtering information based on one or more criteria before the semantic application results are generated. Example criteria include but are not limited to recipes that are compatible with designated food allergies, kosher recipes, preparation time, cooking technique (e.g., fried, grilled, boiled, etc.), type of meal (e.g., breakfast, brunch, lunch, dinner, snack, dessert, etc.), or any other suitable criteria.

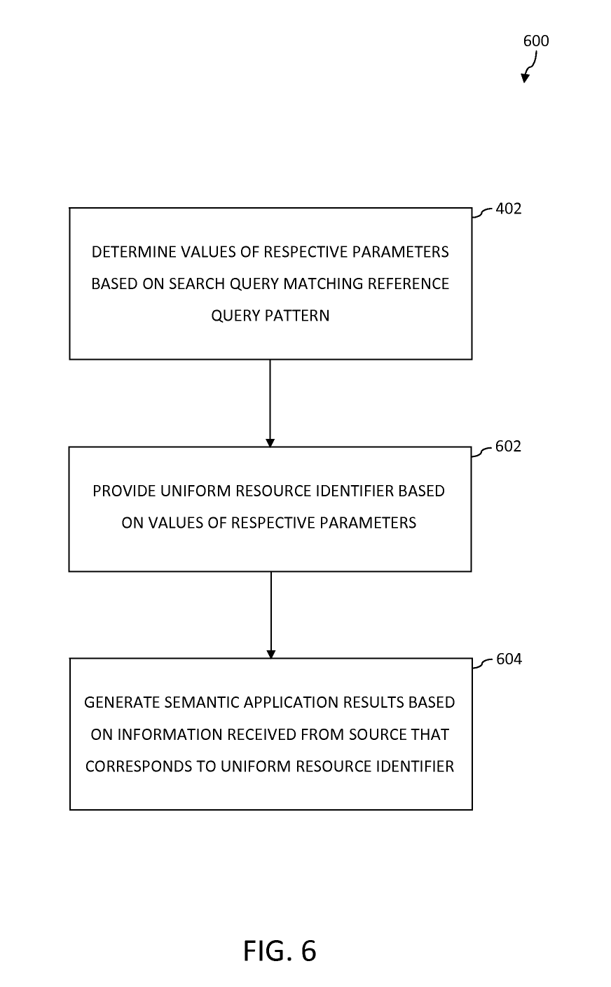

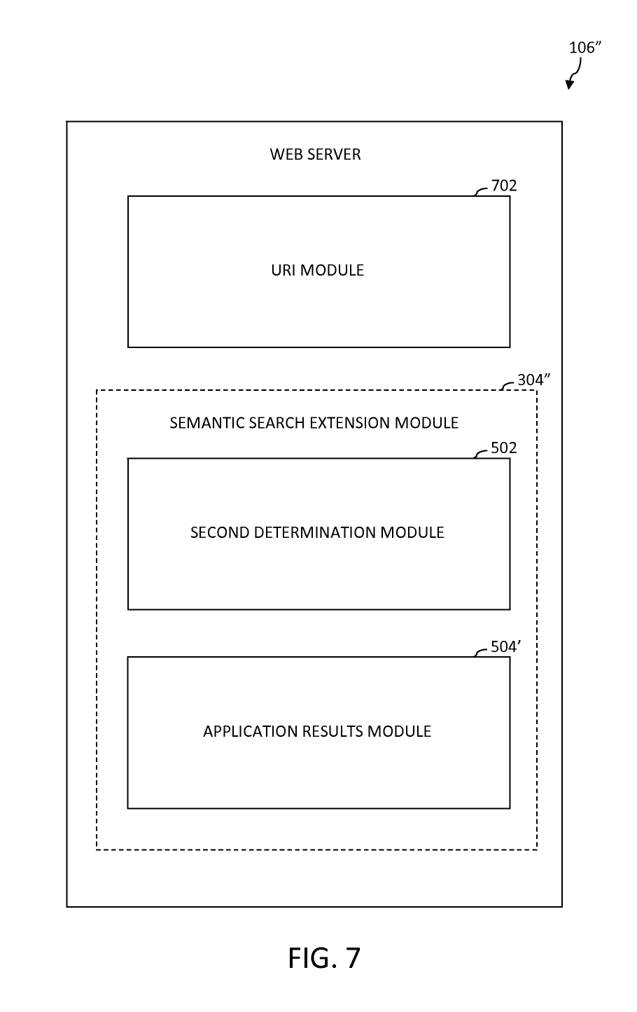

FIG. 6 depicts a flowchart 600 of another method for performing a semantic analysis in accordance with embodiments described herein. Flowchart 600 may be performed by Web server 106 shown in FIG. 1, for example. For illustrative purposes, flowchart 600 is described with respect to a Web server 106″ shown in FIG. 7, which is another example of a Web server 106, according to an embodiment. As shown in FIG. 7, Web server 106″ includes a URI module 702 and a semantic search extension module 304″. Semantic search extension module 304″ includes a second determination module 502 and an application results module 504′. Further structural and operational embodiments will be apparent to persons skilled in the relevant art(s) based on the discussion regarding flowchart 600. Flowchart 600 is described as follows.

As shown in FIG. 6, the method of flowchart 600 begins at step 402. In step 402, values of respective parameters are determined based on a search query matching a reference query pattern. In an example implementation, second determination module 502 determines the values of the respective parameters.

At step 602, a uniform resource identifier (URI) is provided based on the values of the respective parameters. For instance, the uniform resource identifier may include a uniform resource locator (URL) and/or a uniform resource name (URN). For example, providing the URI may include generating the URI based on the values of the respective parameters. In another example, providing the URI may include matching a URI that is stored in a database, for instance, with the values of the respective parameters. In accordance with this example, the URI that matches the values of the respective parameters is provided at step 602. In an example implementation, URI module 702 provides the URI.

In accordance with the first example described above, in which the values of the respective parameters are “flight”, “San Diego”, “Boston”, and “January 23”, the URI may be:
http://www.orbitz.com/smapp?from=sandiego&to=boston&month=jan&day=23.
   This example URI is provided for illustrative purposes and is not intended to be limiting. Persons skilled in the relevant art(s) will recognize that any suitable URI may be provided. In accordance with this example, the values of the parameters are included in the URI for illustrative purposes. It will be recognized, however, that the scope of the example embodiments is not limited in this respect. For instance, the URI need not necessarily include the values of the parameters.

At step 604, semantic application results are generated based on information received from a source that corresponds to the uniform resource identifier. In an example implementation, application results module 504′ generates the semantic application results.

In accordance with the first example described with reference to step 602, semantic application results of an “Orbitz®” application may be generated based on information received from a Web server owned (or otherwise under the control of) Orbitz®. The information may include a list of flights from San Diego to Boston on January 23 that may be purchased through Orbitz®.

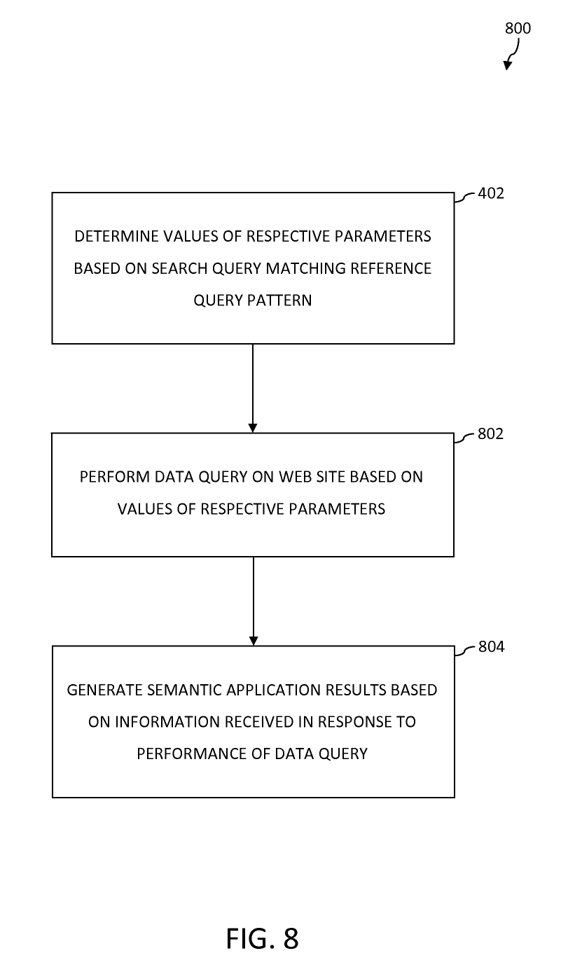

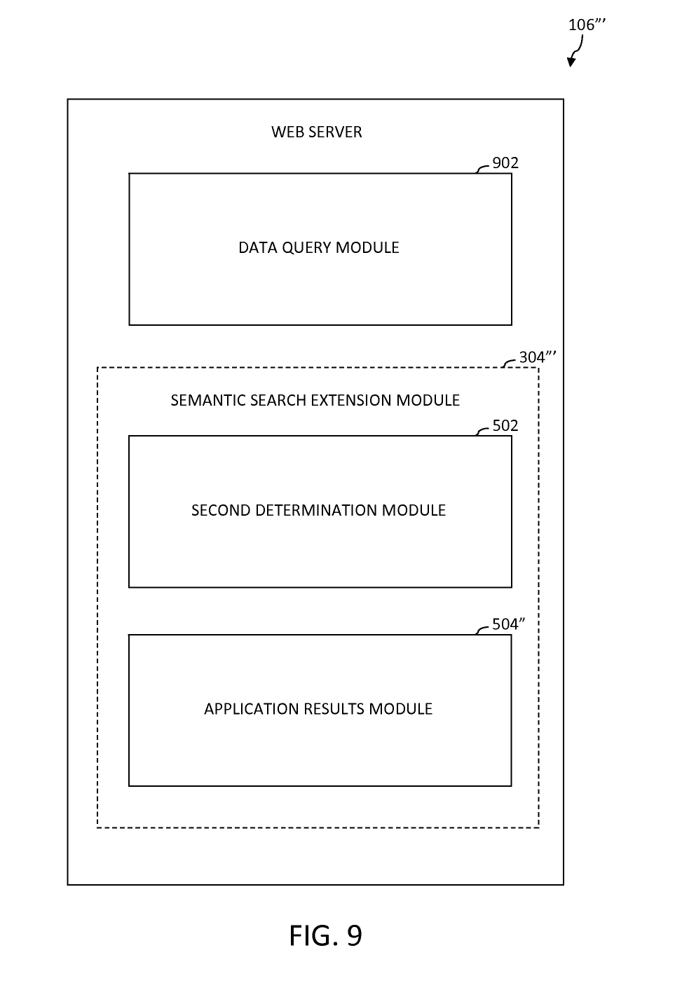

FIG. 8 depicts a flowchart 800 of yet another method for performing a semantic analysis in accordance with embodiments described herein. Flowchart 800 may be performed by Web server 106 shown in FIG. 1, for example. For illustrative purposes, flowchart 800 is described with respect to a Web server 106′″ shown in FIG. 9, which is another example of a Web server 106, according to an embodiment. As shown in FIG. 9, Web server 106′″ includes a data query module 902 and a semantic search extension module 304′″. Semantic search extension module 304′″ includes a second determination module 502 and an application results module 504″. Further structural and operational embodiments will be apparent to persons skilled in the relevant art(s) based on the discussion regarding flowchart 800. Flowchart 800 is described as follows.

As shown in FIG. 8, the method of flowchart 800 begins at step 402. In step 402, values of respective parameters are determined based on a search query matching a reference query pattern. In an example implementation, second determination module 502 determines the values of the respective parameters.

At step 802, a data query is performed on a Web site based on the values of the respective parameters. For example, the data query may be a SPARQL query or any other suitable type of query that is run against a data model. A data model may have any format, including but not limited to a tuple store, a relational database (e.g., a SQL database), or any other suitable format. In an example implementation, data query module 902 performs the data query.

In accordance with the first example described above, in which the values of the respective parameters are “flight”, “San Diego”, “Boston”, and “January 23”, the data query may be:
SELECT ?price FROM (?flight orb:from “San Diego”; orb:to “Boston”; orb:date “01-23-09”).
   This example data query is provided for illustrative purposes and is not intended to be limiting. Persons skilled in the relevant art(s) will recognize that any suitable data query may be performed. In accordance with this example, the data query is executed on the metadata of Web pages in the domain *.orbitz.com. Among these Web pages is at least one Web page that describes a flight from San Diego to Boston on Jan. 23, 2009.

At step 804, semantic application results are generated based on information received in response to performance of the data query. In an example implementation, application results module 504″ generates the semantic application results.

In accordance with the first example described above, the semantic application results include the at least one Web page that describes a flight from San Diego to Boston on Jan. 23, 2009, information extracted therefrom, and/or link(s) thereto.

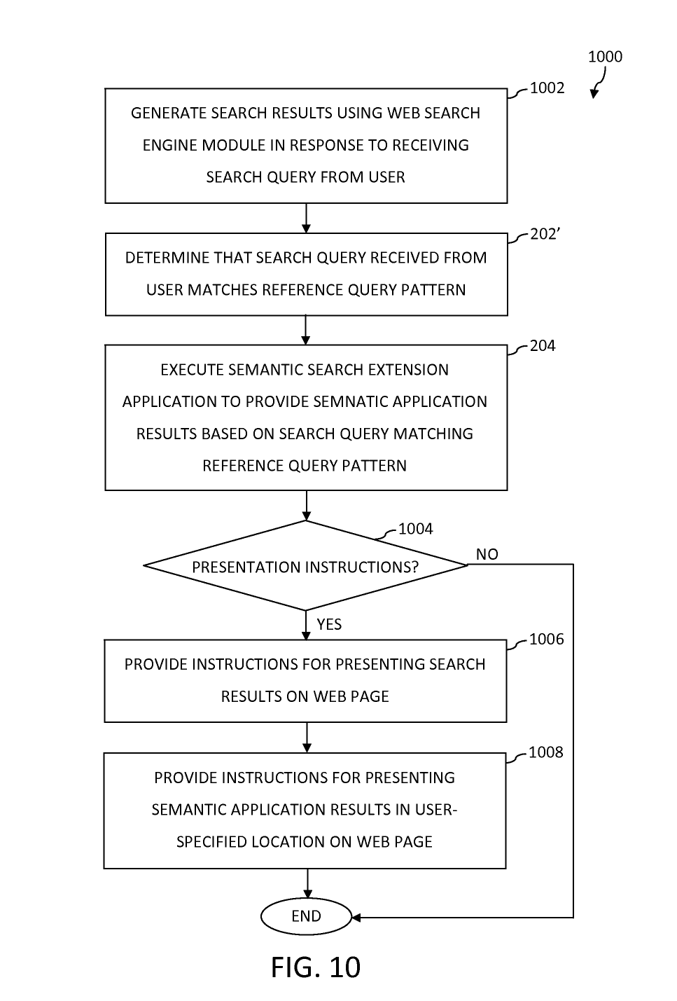

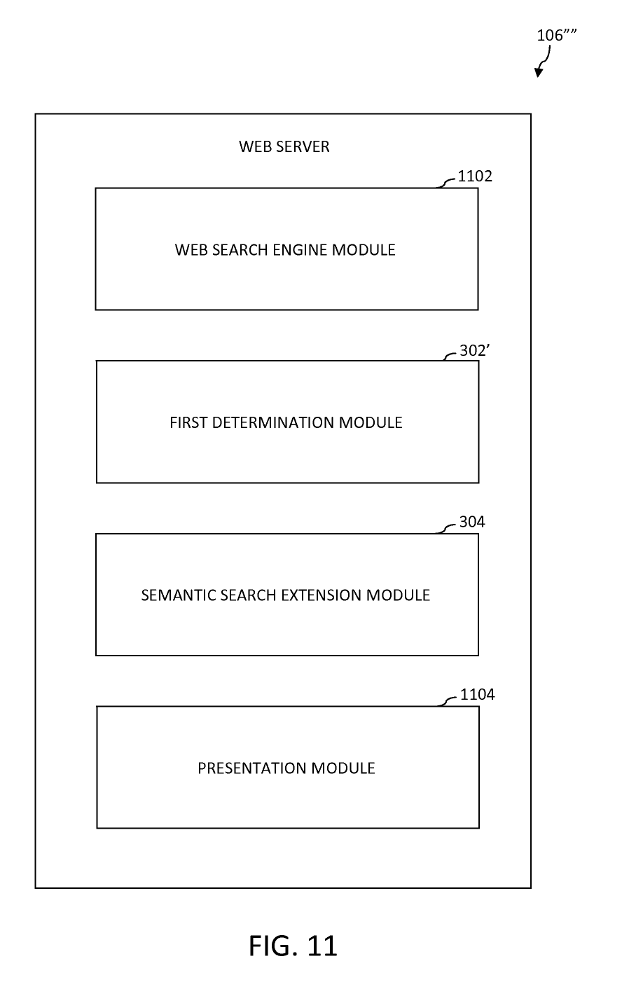

FIG. 10 depicts a flowchart 1000 of another method for utilizing a semantic search extension application in accordance with embodiments described herein. Flowchart 1000 may be performed by Web server 106 shown in FIG. 1, for example. For illustrative purposes, flowchart 1000 is described with respect to a Web server 106″″ shown in FIG. 11, which is another example of a Web server 106, according to an embodiment. As shown in FIG. 11, Web server 106″″ includes a Web search engine module 1102, a first determination module 302′, a semantic search extension module 304, and a presentation module 1104. Further structural and operational embodiments will be apparent to persons skilled in the relevant art(s) based on the discussion regarding flowchart 1000. Flowchart 1000 is described as follows.

As shown in FIG. 10, the method of flowchart 1000 begins at step 1002. In step 1002, search results are generated using a Web search engine module in response to receiving a search query from a user. In an example implementation, Web search engine module 1102 generates the search results.

For example, the search results may be generated using a Yahoo!® Web search engine module developed by Yahoo! Inc. and accessible at www.yahoo.com, a Google™ Web search engine module developed by Google Inc. and accessible at www.google.com, an Ask™ Web search engine module developed by IAC/InterActiveCorp and accessible at www.ask.com, an MSN® Web search engine module developed by Microsoft Corporation and accessible at www.msn.com, or any other suitable Web search engine module.

At step 202′, a determination is made that the search query received from the user matches a reference query pattern. In an example implementation, first determination module 302′ determines that the search query received from the user matches the reference query pattern.

At step 204, a semantic search extension application is executed to provide semantic application results based on the search query matching the reference query pattern. In an example implementation, semantic search extension module 304 executes the semantic search extension application.

According to an embodiment, the semantic application results are further based on the search results. In another embodiment, the semantic application results are not based on the search results. In yet another embodiment, the semantic application results are further based on an aggregation of search results that includes the search results that are generated using the Web search engine module. In accordance with this embodiment, a plurality of Web search engine modules may generate respective search results based on the search query from the user. The search results that are generated by the plurality of Web search engine modules may be aggregated. The semantic application results may be further based on such aggregated search results.

At step 1004, a determination is made as to whether presentation instructions are received regarding the search results and the semantic application results. If the presentation instructions are not received, flowchart 1000 ends. If the presentation instructions are received, however, flow continues to step 1006.

At step 1006, instructions are provided for presenting the search results on a Web page. At step 1008, instructions are provided for presenting the semantic application results in a user-specified location on the Web page. For example, the user may specify that the semantic application results are presented at the top of the Web page (e.g., as a north border of the Web page). In another example, the user may specify that the semantic application results are presented on the right side of the Web page (e.g., as an east border of the Web page). These example user-specified locations are provided for illustrative purposes and are not intended to be limiting. The user may specify any suitable location for presentation of the semantic application results. In an example implementation, presentation module 1104 performs steps 1004, 1006, and 1008.

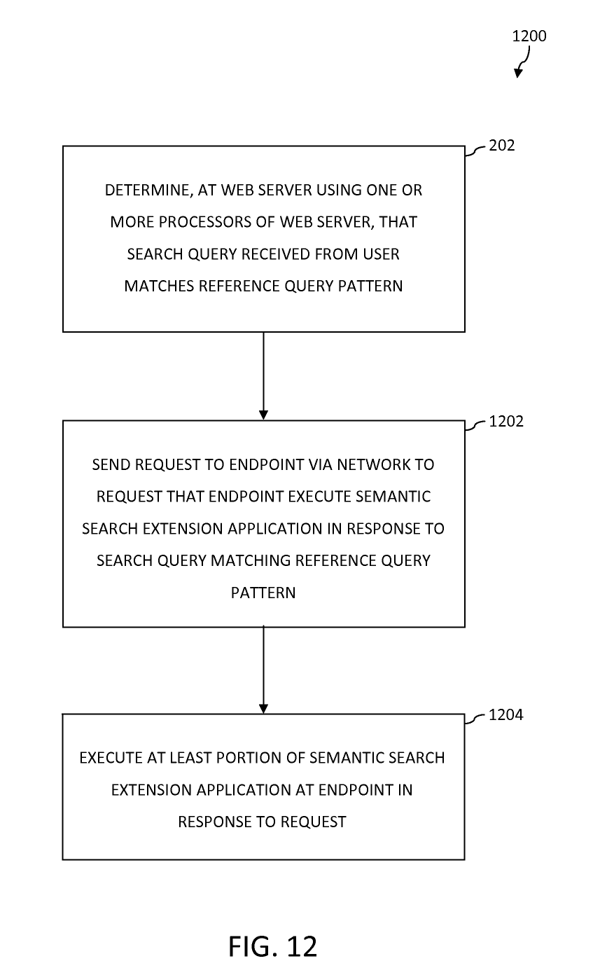

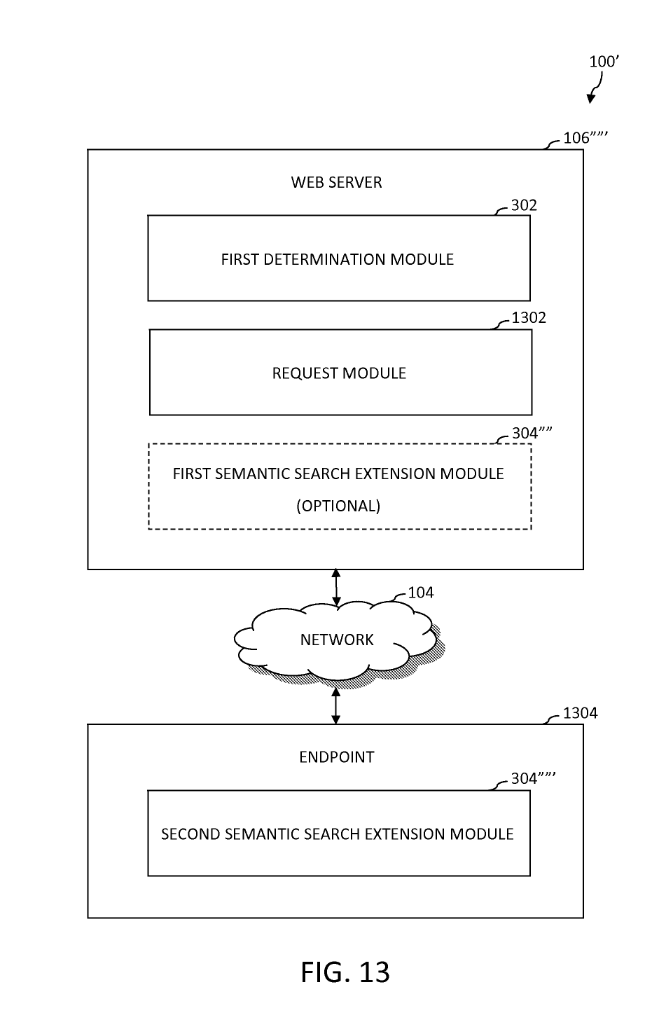

FIG. 12 depicts a flowchart 1200 of yet another method for utilizing a semantic search extension application in accordance with embodiments described herein. Flowchart 1200 may be performed by computer system 100 shown in FIG. 1, for example. For illustrative purposes, flowchart 1200 is described with respect to a computer system 100′ shown in FIG. 13, which is an example of a computer system 100, according to an embodiment.

As shown in FIG. 13, computer system 100′ includes a Web server 106″″′, a network 104, and an endpoint 1304. Web server 106″″′ includes a first determination module 302, a request module 1302, and an optional first semantic search extension module 304″″. Endpoint 1304 includes a second semantic search extension module 304″″′. Further structural and operational embodiments will be apparent to persons skilled in the relevant art(s) based on the discussion regarding flowchart 1200. Flowchart 1200 is described as follows.

As shown in FIG. 12, the method of flowchart 1200 begins at step 202. In step 202, a determination is made that a search query received from a user matches a reference query pattern. The determination is made at a Web server using one or more processors of the Web server. In an example implementation, first determination module 302 of Web server 106″″′ in FIG. 13 determines that the search query received from the user matches the reference query pattern.

At step 1202, a request is sent to an endpoint via a network to request that the endpoint execute a semantic search extension application in response to the search query matching the reference query pattern. An endpoint is a computer (e.g., server) or other processing system, including one or more processors, that is capable of executing at least a portion of a semantic search extension application. The endpoint may be a Web server that is included in the plurality of Web servers 106A-106N shown in FIG. 1, for example, or any other suitable endpoint. For instance, the request may be in the form of an HTTP request or other suitable request that the endpoint is capable of interpreting. In an example implementation, request module 1302 of Web server 106″″′ in FIG. 13 sends the request to the endpoint.

At step 1204, at least a portion of the semantic search extension application is executed at the endpoint in response to the request. In an example implementation, second semantic search extension module 304″″′ of endpoint 1304 performs at least a portion of the semantic search extension application.

According to an embodiment, second semantic search extension module 304″″ performs all aspects of the semantic search extension application. In accordance with this embodiment, Web server 106″″′ need not necessarily include first semantic search extension module 304″″. For example, second semantic search extension module 304″″′ may determine values of respective parameters based on the search query matching the reference query pattern. In another example, second semantic search extension module 304″″′ may generate semantic application results for presentation to the user based on the values of the respective parameters.

In accordance with another embodiment, first semantic search extension module 304″″ determines values of respective parameters based on the search query matching the reference query pattern. In further accordance with this embodiment, second semantic search extension module 304″″′ generates semantic application results for presentation to the user based on the values of the respective parameters.

According to yet another embodiment, second semantic search extension module 304″″′ determines values of respective parameters based on the search query matching the reference query pattern. In accordance with this embodiment, first semantic search extension module 304″″ generates semantic application results for presentation to the user based on the values of the respective parameters.

### III. Example Computer Implementation

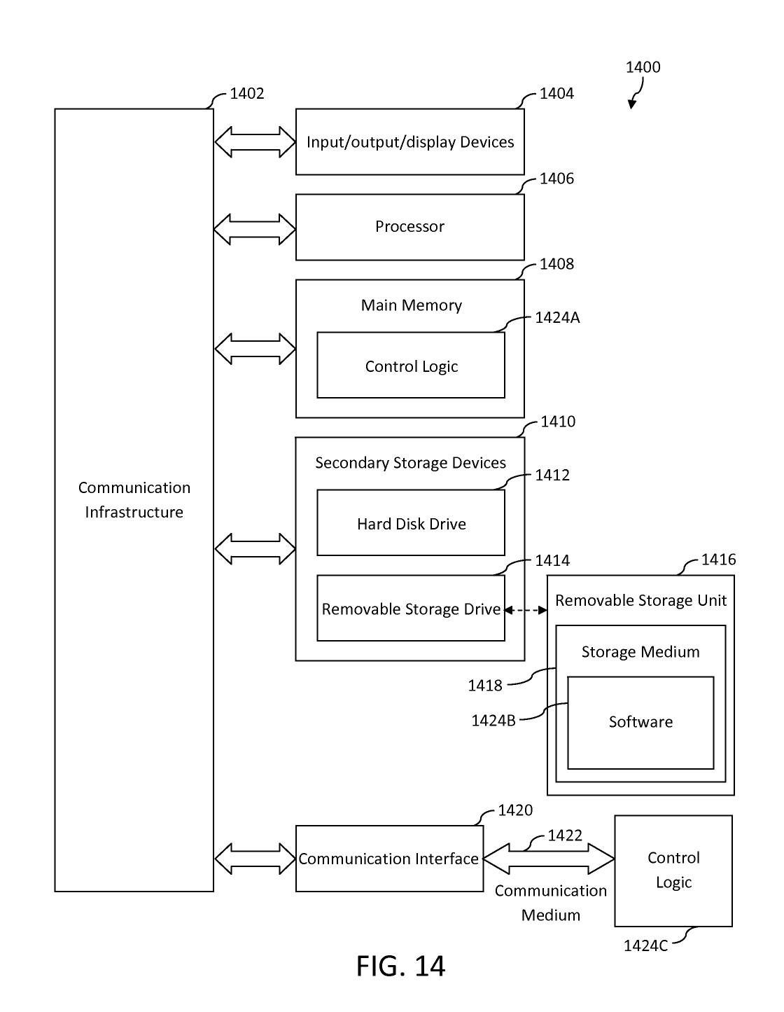

The embodiments described herein, including systems, methods/processes, and/or apparatuses, may be implemented using well known computers, such as computer 1400 shown in FIG. 14. For example, elements of example computer system 100, including user systems 102A-102M depicted in FIG. 1, Web servers 106A-106N depicted in FIGS. 1, 3, 7, 9, 11, and 13 and elements thereof, endpoint 1304 depicted in FIG. 13 and elements thereof, and each of the steps of flowcharts 200, 400, 600, 800, 1000, and 1200 depicted in respective FIGS. 2, 4, 6, 8, 10, and 12, can each be implemented using one or more computers 1400.

Computer 1400 can be any commercially available and well known computer capable of performing the functions described herein, such as computers available from International Business Machines, Apple, Sun, HP, Dell, Cray, etc. Computer 1400 may be any type of computer, including a desktop computer, a server, etc.

As shown in FIG. 14, computer 1400 includes one or more processors (e.g., central processing units (CPUs)), such as processor 1406. Processor 1406 may include first determination module 302 of FIGS. 3, 11, and 13, semantic search extension module 304 of FIGS. 3, 5, 7, 9, 11, and 13, second determination module 502 of FIGS. 5, 7, and 9, application results module 504 of FIGS. 5, 7, and 9, URI module 702 of FIG. 7, data query module 902 of FIG. 9, Web search engine module 1102 of FIG. 11, presentation module of FIG. 11, or request module 1302 of FIG. 13, or any portion or combination thereof, for example, though the scope of the embodiments is not limited in this respect. Processor 1406 is connected to a communication infrastructure 1402, such as a communication bus. In some embodiments, processor 1406 can simultaneously operate multiple computing threads.

Computer 1400 also includes a primary or main memory 1408, such as a random access memory (RAM). Main memory has stored therein control logic 1424A (computer software), and data.

Computer 1400 also includes one or more secondary storage devices 1410. Secondary storage devices 1410 include, for example, a hard disk drive 1412 and/or a removable storage device or drive 1414, as well as other types of storage devices, such as memory cards and memory sticks. For instance, computer 1400 may include an industry standard interface, such as a universal serial bus (USB) interface for interfacing with devices such as a memory stick. Removable storage drive 1414 represents a floppy disk drive, a magnetic tape drive, a compact disk drive, an optical storage device, tape backup, etc.

Removable storage drive 1414 interacts with a removable storage unit 1416. Removable storage unit 1416 includes a computer useable or readable storage medium 1418 having stored therein computer software 1424B (control logic) and/or data. Removable storage unit 1416 represents a floppy disk, magnetic tape, compact disc (CD), digital versatile disc (DVD), Blue-ray disc, optical storage disk, memory stick, memory card, or any other computer data storage device. Removable storage drive 1414 reads from and/or writes to removable storage unit 1416 in a well known manner.

Computer 1400 also includes input/output/display devices 1404, such as monitors, keyboards, pointing devices, etc.

Computer 1400 further includes a communication or network interface 1420. Communication interface 1420 enables computer 1400 to communicate with remote devices. For example, communication interface 1420 allows computer 1400 to communicate over communication networks or mediums 1422 (representing a form of a computer useable or readable medium), such as local area networks (LANs), wide area networks (WANs), the Internet, etc. Network interface 1420 may interface with remote sites or networks via wired or wireless connections. Examples of communication interface 1422 include but are not limited to a modem, a network interface card (e.g., an Ethernet card), a communication port, a Personal Computer Memory Card International Association (PCMCIA) card, etc.

Control logic 1424C may be transmitted to and from computer 1400 via the communication medium 1422.

Any apparatus or manufacture comprising a computer useable or readable medium having control logic (software) stored therein is referred to herein as a computer program product or program storage device. This includes, but is not limited to, computer 1400, main memory 1408, secondary storage devices 1410, and removable storage unit 1416. Such computer program products, having control logic stored therein that, when executed by one or more data processing devices, cause such data processing devices to operate as described herein, represent embodiments of the invention.

For example, each of the elements of example Web server 106 and its sub-elements, including first determination module 302 depicted in FIGS. 3, 11, and 13; semantic search extension module 304 depicted in FIGS. 3, 5, 7, 9, 11, and 13 and its sub-elements, including second determination module 502 and application results module 504, each depicted in FIGS. 5, 7, and 9; URI module 702 depicted in FIG. 7; data query module 902 depicted in FIG. 9; Web search engine module 1102 and presentation module 1104, each depicted in FIG. 11; request module 1302 depicted in FIG. 13; and each of the steps of flowcharts 200, 400, 600, 800, 1000, and 1200 depicted in respective FIGS. 2, 4, 6, 8, 10, and 12 can be implemented as control logic that may be stored on a computer useable medium or computer readable medium, which can be executed by one or more processors to operate as described herein.

The invention can be put into practice using software, hardware, and/or operating system implementations other than those described herein. Any software, hardware, and operating system implementations suitable for performing the functions described herein can be used.

### IV. Conclusion

While various embodiments have been described above, it should be understood that they have been presented by way of example only, and not limitation. It will be apparent to persons skilled in the relevant art(s) that various changes in form and details can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A method comprising:
determining, at a Web server using one or more processors of the Web server, that a search query received from a user matches a reference query pattern;
executing a semantic search extension application in response to determining that the search query matches the reference query pattern, the executing the semantic search extension application including:
determining values of respective parameters based on the search query matching the reference query pattern; and
generating semantic application results for presentation to the user based on the values of the respective parameters.

2. The method of claim 1, wherein determining that the search query matches the reference query pattern comprises:
determining that the search query matches a reference query pattern defined by the user.

3. The method of claim 1, wherein determining that the search query matches the reference query pattern comprises:
determining that the search query matches a reference query pattern associated with a class of queries that includes the search query received from the user.

4. The method of claim 1, wherein executing the semantic search extension application comprises:
executing a semantic search extension application defined by the user.

5. The method of claim 1, wherein executing the semantic search extension application comprises:
executing an algorithmic semantic search extension application.

6. The method of claim 1, wherein executing the semantic search extension application comprises:
executing a semantic search extension application based on a template that is associated with a class of queries that includes the search query received from the user.

7. The method of claim 1, wherein executing the semantic search extension application comprises:
executing a semantic search extension application that is based on a query history of the user.

8. The method of claim 1, wherein the executing the semantic search extension application further includes:
providing a uniform resource identifier based on the values of the respective parameters;
wherein the generating the semantic application results comprises:
generating the semantic application results based on information received from a source that corresponds to the uniform resource identifier.

9. The method of claim 1, wherein the executing the semantic search extension application further includes:
performing a data query on a Web site based on the values of the respective parameters;
wherein the generating the semantic application results comprises:
generating the semantic application results based on information received in response to performance of the data query.

10. The method of claim 1, wherein the executing the semantic search extension application comprises:
executing a plurality of semantic search extension applications in response to determining that the search query matches the reference query pattern, the executing the plurality of semantic search extension applications including:
generating a plurality of semantic application results corresponding to the plurality of respective semantic search extension applications for presentation to the user based on the search query matching the reference query pattern.

11. The method of claim 1, further comprising:
sending a request to an endpoint via a network to request that the endpoint perform at least a portion of the execution of the semantic search extension application in response to the search query matching the reference query pattern;
wherein the generating the semantic application results is performed by the endpoint.

12. The method of claim 1, further comprising:
sending a request to an endpoint via a network to request that the endpoint perform at least a portion of the execution of the semantic search extension application in response to the search query matching the reference query pattern;
wherein the determining the values of the respective parameters is performed by the endpoint.

13. The method of claim 1, further comprising:
generating search results using a Web search engine module in response to receiving the search query from the user.

14. The method of claim 13, wherein the semantic application results are further based on the search results.

15. The method of claim 13, wherein the semantic application results are not based on the search results.

16. The method of claim 13, wherein the semantic application results are further based on an aggregation of search results that includes the search results that are generated using the Web search engine module.

17. The method of claim 13, further comprising:
providing instructions for presenting the search results on a Web page; and
providing instructions for presenting the semantic application results in a user-specified location on the Web page.

18. A Web server comprising:
a first determination module configured to determine that a search query received from a user matches a reference query pattern;
a semantic search extension module configured to execute a semantic search extension application in response to the search query matching the reference query pattern, the semantic search extension module including:
a second determination module configured to determine values of respective parameters based on the search query matching the reference query pattern; and
an application results module configured to generate semantic application results for presentation to the user based on the values of the respective parameters.

19. The Web server of claim 18, wherein the semantic search extension module further includes:
a URI module configured to provide a uniform resource identifier based on the values of the respective parameters;
wherein the semantic application results are based on information received from a source that corresponds to the uniform resource identifier.

20. The Web server of claim 18, wherein the semantic search extension module further includes:
a data query module configured to perform a data query on a Web site based on the values of the respective parameters;
wherein the semantic application results are based on information received in response to performance of the data query.

21. The Web server of claim 18, further comprising:
a Web search engine module configured to generate search results based on the search query received from the user;
wherein the semantic application results are further based on the search results.

22. The Web server of claim 18, further comprising:
a Web search engine module configured to generate search results based on the search query received from the user;
wherein the semantic application results are not based on the search results.

23. A computer program product comprising a computer-readable medium having computer program logic recorded thereon for enabling a processor-based system to take into consideration an intent of a user with respect to a search query received from the user, comprising:
a first program logic module for enabling the processor-based system to determine that the search query received from the user matches a reference query pattern; and
a second program logic module for enabling the processor-based system to execute a semantic search extension application in response to the search query matching the reference query pattern;
the second program logic module including instructions for enabling the processor-based system to determine values of respective parameters based on the search query matching the reference query pattern; and
the second program logic module further including instructions for enabling the processor-based system to generate semantic application results for presentation to the user based on the values of the respective parameters.
